(19) United States
(12) Patent Application Publication
(10) Pub. No.: US 2002/0042660 A1
(43) Pub. Date: Apr. 11, 2002

(54) System for remote activation and control of water play elements

(76) Inventor: Dean M. Atkinson, Jacksonville, FL (US)

Correspondence Address: Jeffrey C. Maynard, Draughon Professional Association, Suite 2000, One Independent Drive, Jacksonville, FL, 32202, US

(21) Appl. No.: 09/973,237

(22) Filed: Oct. 9, 2001

Related U.S. Application Data
(60) Provisional application No. 60/239,039, filed on Oct. 10, 2000.

(51) Int. Cl. G05B 19/18; G05B 15/00

(52) U.S. Cl. 700/65; 700/83

(57) ABSTRACT

A new system for water play structures is enabled wherein the system includes a capacity to remotely activate the play structure and operates to control and choreograph unique water play elements. An activated system performs through valve manipulation to control and choreograph water elements. Signals initiated by an operator or participant of the present invention direct the system to control and choreograph unique water play elements to provide intellectual, recreational, and aesthetic enjoyment to an operator, observer, or participant.

This Application claims the benefit of U.S. Provisional Application, Serial No. 60/239,039 entitled System for remote activation and control of water play elements, filed with the U.S. Patent and Trademark Office on Oct. 10, 2000.

### BACKGROUND OF THE INVENTION

1. Field of the Invention

This invention relates generally to a method and system for choreographing water play elements. Specifically, the present invention teaches a computerized system to operate and control water elements as part of a water playground structure.

2. Background of the Prior Art

In the past few decades, the production and manufacture of water recreational structures has expanded dramatically to accommodate the growth of water parks and increased public interest in water entertainment. The majority of current water play structures attempt to provide interaction between participants and the water play structure. Often, those structures comprise components, such as wheels, ropes, chains or handles that activate water play elements to provide structural interactive enjoyment. Those components frequently pose hazards to young participants, particularly small children. For example, potential injuries such as pinching, choking and collisions from twisting wheels and pull ropes are likely to occur with young individuals. Additionally, those interactive play elements supply limited water effects.

Generally, current water playground structures are activated manually and lack systems for choreographed water features. While eliminating potential dangers of present play components, the subject invention also provides an alternative to manual water system activation. Furthermore, the present invention offers a means for increased water conservation while enhancing participant enjoyment through the programmable control of water features.

At present, there are no water play structures that incorporate the system of water activation and manipulation contemplated by the subject invention. For example, a water play arrangement is offered in an amusement ride where sensors provide inputs from passenger signals whereby various ride elements, including water elements, are affected by the signal inputs. The amusement vehicle primarily focuses on providing remote passenger control of ride elements. This arrangement, however, does not address the utilization of computer systems in controlling interactive water play elements nor does it relate to the remote activation and control of a water system in a stationary ground structure.

Stationary structures are also available for water entertainment whereby variable water spray patterns are generated for amusement. The primary objective of such device is to provide a versatile water dispensing apparatus for play and amusement that can be configured to spray various patterns of water at various pressure levels. The device lacks a remote means of activation; rather, the device is activated purely through manual means. Moreover, control of water sprays and water pressure is also performed through manual manipulation, not through a computer system programmed to automatically alter water spray and pressure.

Additionally, a device is available where predetermined informational patterns are displayed in a pool of water in accordance with operating instructions from a computer program controlling output terminals connected to solenoid valves. Specifically, images are formed by air bubbles generated by the opening and closing of solenoid valves controlled by a computer system to provide form letters, numbers, pictures or other visually apparent figures. Once again, this device makes no provisions regarding a remote activation of the water system for a play structure. Additionally, means for participant control of water pressure as well as various water elements other than bubbles were not included.

### SUMMARY OF THE INVENTION

The subject invention provides a system to eliminate potential hazards and stimulate imagination by causing activation of random water play features. Additionally, the subject system enables remote activation as well as of water pressure alteration.

One object of the present invention is to provide a safe environment for young children around water play structures. By utilizing a computerized system for altering water elements without having the children personally manipulate potentially dangerous structural components, children and adults are provided a means for interacting with the play structure while still maintaining a high degree of safety.

It is another objective of the present invention to decrease the potential liability often associated with water play structures having a multiplicity of components for entertainment. By removing those items such as steering wheels and pull-chains and substituting buttons to be pushed, children are less likely to be harmed and the liability associated with accidents related to such components may be reduced.

It is yet another objective of the present invention to provide ease of system activation. Specifically, the present invention offers a system with the capability for remote activation. For example, the system may be activated by an infrared sensor, timer or through wireless digital or electrical activation.

Yet another object of the present invention is to stimulate the imagination of youthful and mature minds alike. Often, water elements are continuously supplied in a singular fashion through actuated in-line valves. Water elements tend to remain steadily invariable while children or adults play. The subject invention provides choreographed water play elements of varying arrangements with varying pressures to stimulate the imagination. Moreover, the present system also enables children and adults to manipulate water play elements to create several water features to stimulate the imagination and permit high educational interaction.

It is another objective of the present invention to provide an educational experience in a playful environment. It is often the case that children merely entertain themselves individually while attending water structures. However, with the present invention, children and adults alike have an opportunity to interact with each other through the manipulation of various features located in and around the structure to activate water play elements.

It is another objective of the present invention to conserve water by enabling a system to control water pressure and recirculation of water. The subject invention also discloses a means for altering water pressure and choreographing water elements through computerized manipulation of valves. Moreover, a system is disclosed whereby the water is constantly recirculated throughout the play structure so as to ensure ease of activation while maintaining water conservation.

Other objectives and goals will be apparent from the following description taken in conjunction with the drawings included herewith. The various features of novelty that characterize the invention will be pointed out with particularity in the claims of this application.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 illustrates a generalized view of an embodiment of the present invention.

### DETAILED DESCRIPTION OF THE INVENTION

The invention summarized above and defined by the enumerated claims may be better understood by referring to the following detailed description, which should be read in conjunction with the accompanying drawings. This detailed description of a particular embodiment, set out below to enable one to practice the invention, is not intended to limit the enumerated claims, but to serve as a particular example thereof. Those skilled in the art should appreciate that they can readily use the concepts and specific embodiment disclosed as a basis for modifying or designing other methods and systems for carrying out the same purposes of the present invention. Those skilled in the art should also realize that such equivalent methods and systems do not depart from the spirit and scope of the invention in its broadest form.

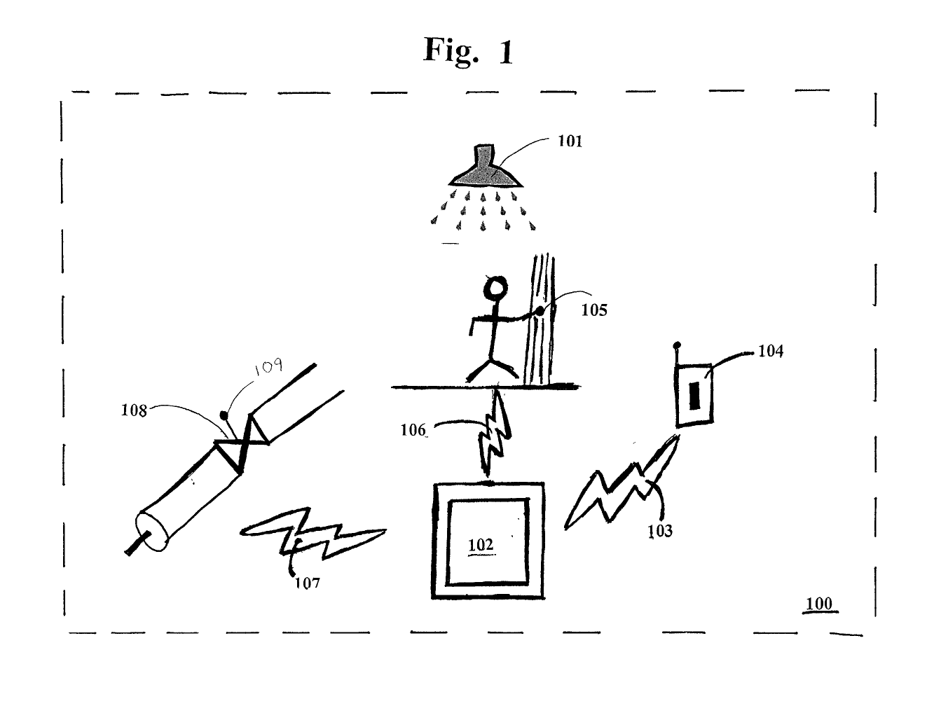

FIG. 1 depicts a system 100 for activating and manipulating water feature 101 to be used on a water play structure. Such system has a programmable logic computer (PLC) 102 having a means for receiving activation signal 103. PLC 102 activation is accomplished by receiving an activation signal 103 generated by a switch 104. Both the PLC 102 and the activation switch 104 need not be located on or near the water play structure. For example, the PLC 102 may be located on the structure, near the structure, or distantly from the water play structure. Similarly, a switch 104 to activate the PLC 102 may also be located on the structure, near the structure, or distantly from the water play structure. Activation signal 103 to start PLC 102 operation may include, but is not limited to an, infra-red signal, pneumatic signal, electrical signal, radio signal or mechanical signal. In an embodiment of the subject invention, a means for activating the PLC 102 is remotely located from the water structure in a portable control box.

Once activated, PLC 102 accesses a pre-programmed file to administer a series of operation signals 107. The operation signals 107 are transmitted to a plurality of valve receptors 109 to manipulate a variety of valves 108 on the water play structure to produce a choreographed display of water feature 101. To process the pre-programmed series of operation signals 107, PLC 102 includes a means for storing and administering a plurality of programs developed to manipulate valve 108 functions in choreographing water play feature 101. An embodiment of the present invention includes program files that initiate such operation signals 107 to instruct specific valves 108 to function at specific time intervals. Such valves 108 are attached to pipes conducting a variety of water features 101 using such means as nozzles attached to water buckets, sprinkler heads, over-head sprays, umbrellas, hoses, or the like to alter water distribution to participants.

Additionally, operation of PLC 102 may be accomplished through a plurality of participant signal switches 105. Specifically, participants may interact with a water play structure by activating a participant signal switch 105 and causing an interactive participant signal 106 to be sent to the PLC 102 to commence a specified choreographed water feature 101 on the play structure.

For participants to operate and vary water feature 101, participants may cause interactive participant signal 106 to be sent to a PLC 102 by simply stepping through an infra-red sensor, press-button, speaking into a microphone or performing an action to activate a participant signal switch 105. Interactive participant signal 106 to activate PLC 102 may include, but is not limited to an, infra-red signal, pneumatic signal, electrical signal, radio signal or mechanical signal.

Once PLC 102 receives interactive participant signal 106, it accesses a pre-programmed file to administer a series of operation signals 107. The operation signals 107 are transmitted to a plurality of valve receptors 109 to manipulate a variety of valves 108 on the water play structure to produce a choreographed display of water feature 101. To process the pre-programmed series of operation signals 107, PLC 102 includes a means for storing and administering a plurality of programs developed to manipulate valve 108 functions in effectuating choreographed water play feature 101. Such choreographed water feature 101 comprises such features as a ten second interval display of water showers, then water sprinklers, and then water sprays, or the like. An embodiment of the subject invention includes a structure enabling a plurality of switches located on a water play structure to permit participants to direct choreographed water distribution.

PLC 102 acts upon valve 108 by relaying an operation signal 107 to a valve receptor 109. Valve 108 functions to alter water flow through a pipe attached to a water play structure as directed by operation signal 107. Operation signal 107 from PLC 102 may be transmitted using a radio signal, an electronic signal, a mechanical signal, or the like. In an embodiment of the present invention, operation signal 107 from PLC 102 may cause a valve to be either open or closed to choreograph water features. In another embodiment, a signal from a PLC will cause a valve with the ability to manipulate water flow to affect water pressure and thereby choreograph water feature 101.

In an embodiment of the present invention, activation and manipulation of water play elements on a play structure is enabled by a PLC, a single activation switch, and at least one pipe having at least one nozzle to effectuate water elements and at least one valve to control water flow to such nozzle. Specifically, the activation switch comprises a touch button located on a play structure enabling a pneumatic activation signal to be delivered to a PLC receptor. Accordingly, the PLC processes the signal and initiates a pre-programmed series of operation signals. The operation signals instruct a pipe valve to distribute water flow as programmed to a nozzle in executing choreographed water features on the water play structure. Choreographed water features may include a water cascade executed in five second intervals, a water spray executed for five seconds, or the like.

In another embodiment of the present invention, activation and manipulation of water play elements on a play structure is enabled by a PLC, a plurality of switches located on a water play structure, a remote activation switch, and a plurality of pipes having at least one nozzle to effectuate water elements and a plurality of valves to control water flow to a nozzle. Specifically, a remotely activated switch is utilized to signal via radio signals the activation of the PLC, though no water has been distributed onto the play structure. Once activated, the PLC awaits further signals from participant switches located throughout the water play structure to effectuate valves in choreographing water features. Infrared sensors located throughout the water play structure can be triggered by participants to send an interactive participant signal to the PLC. The PLC then processes the interactive participant signal and administers a pre-programmed series of operation signals to a plurality of valves attached to pipes of the water play structure. Once a valve receives the signal, it functions to alter water flow to effectuate choreographed water features to enhance participant enjoyment and learning.

Another embodiment of the present invention, a play structure is additionally enabled by permit continual water distribution onto the play structure while simultaneously incorporating choreographed water play features resulting from participant interaction. Specifically, an activation switch is utilized to signal PLC activation. The activated PLC then initiates water distribution onto the play structure by relaying operation signals to a valve. Once activated and water distribution completed, the PLC awaits further signals from participant switches located throughout the water play structure to effectuate a valve in choreographing water features. A switch located on the water play structure can be triggered by participants to send an interactive participant signal to the PLC. The PLC then processes the interactive participant signal and administers a pre-programmed series of signals to a plurality of valves attached to pipes of the water play structure. Once a valve receives the signal, it functions to alter water flow to effectuate choreographed water features to enhance participant enjoyment and learning.

By enabling a computerized system for altering water play elements, either through a pre-composed program or through participant interaction with various switches, children and adults are provided a means for increased entertainment while maintaining a high degree of safety. Moreover, with a capability for remote activation and control of water distribution, the present invention offers ease of operation.

While specific values, relationships, materials and steps have been set forth for purposes of describing concepts of the invention, it should be recognized that, in the light of the above teachings, those skilled in the art can modify those specifics without departing from basic concepts and operating principles of the invention taught herein. Therefore, for purposes of determining the scope of patent protection, reference shall be made to the appended claims in combination with the above detailed description.

What is claimed is:

1. A system for water play apparatus comprising:
a. a water play structure;
b. a valve and valve operation means attached to said valve for controlling valve activity;
c. a participant switch for generating a signal based on user interaction with the water play structure; and
d. a programmable computer means for receiving the signal from the participant switch and for generating a signal to prompt valve operation means.

2. The system of claim 1, wherein the valve operation means is a micro-controller, said micro-controller comprising a means for receiving signals generated by the programmable computer.

3. The system of claim 1, wherein the programmable computer means further comprises a means for storing at least one program to generate a specific series of signals to valve operation means.

4. The system of claim 1, wherein the signal generated by the participant switch is selected from the group consisting of:
a. an infrared signal;
b. an electrical signal;
c. a radio signal;
d. a pneumatic signal; and
e. a mechanical signal.

5. The system of claim 1, wherein the participant switch is selected from the group consisting of:
a. a push button; and
b. an infrared sensor.

6. The system of claim 1, wherein the participant switch further comprises a participant switch located on the water play structure.

7. The system of claim 1, wherein said means for directing water into a spray pattern comprises:
a. at least one nozzle;
b. at least one spray hole;
c. at least one water cascade; and
d. at least one rainfall.

8. The system of claim 1, further comprising an operator switch, wherein said operator switch generates a signal to activate the programmable computer means.

9. The system of claim 8, wherein the signal generated by the operator switch is selected from the group consisting of:
a. an infrared signal;
b. an electrical signal;
c. a radio signal;
d. a pneumatic signal; and
e. a mechanical signal.

10. The system of claim 8, wherein the operator switch for activating the water play structure is selected from the group consisting of:
a. a push button; and
b. an infrared sensor.

11. The system of claim 8, wherein the operator switch further comprises an operator switch located on a water play structure, an operator switch located on a remote control device, and an operator switch located on the programmable computer means.

12. The system of claim 1, wherein said water play structure comprises a frame, at least one means mounted on such structure for directing water into a spray pattern, a means for circulating water to said means for directing water into a spray pattern, and at least one valve fluidly coupled to such means for circulating water to control the flow of water circulated to such means for directing water into a spray pattern.

13. The system of claim 12, wherein said water circulating means comprises a pipe and a pump.

14. The system of claim 13, wherein said water circulating means further comprises a filter.

15. A system for water play apparatus comprising:
a. a water play structure; said water play structure comprising a frame, multiple pipes, multiple means mounted on such structure for directing water into a spray pattern, a filter, a pump, and multiple valves fluidly coupled to such pipes to control the flow of water circulated to such means for directing water into a spray pattern;
b. a micro-controller attached to said valve for controlling valve activity;
c. an operator switch for generating a signal based on operator activation of the water play structure;
d. a participant switch for generating a signal based on user interaction with the water play structure; and
e. a programmable computer means for receiving the signal from the participant switch or the operator switch and for generating a signal to prompt valve operation means.

16. The system of claim 15 wherein the signal generated by the operator switch is selected from the group consisting of:
a. an infrared signal;
b. an electrical signal;
c. a radio signal;
d. a pneumatic signal; and
e. a mechanical signal.

17. The system of claim 15 wherein the operator switch for activating the water play structure is selected from the group consisting of:
a. a push button; and
b. an infrared sensor.

18. The system of claim 15, wherein the operator switch further comprises an operator switch located on a water play structure, an operator switch located on a remote control device, and an operator switch located on the programmable computer means.

19. The system of claim 15 wherein the programmable computer means further comprises a means for storing at least one program to generate a specific series of signals to valve operation means.

20. The system of claim 15 wherein the signal generated by the participant switch is selected from the group consisting of:
a. an infrared signal;
b. an electrical signal;
c. a radio signal;
d. a pneumatic signal; and
e. a mechanical signal.

21. The system of claim 15 wherein the participant switch is selected from the group consisting of:
a. a push button; and
b. an infrared sensor.

22. The system of claim 15 wherein the participant switch further comprises a participant switch located on the water play structure.

23. The system of claim 15 wherein said means for directing water into a spray pattern comprises:
a. at least one nozzle;
b. at least one spray hole;
c. at least one water cascade; and
d. at least one rainfall.
